(19) United States
(12) Patent Application Publication
(10) Pub. No.: US 2026/0194338 A1
(43) Pub. Date: Jul. 9, 2026

(54) SPECTRAL DOMAIN OPTICAL COHERENCE TOMOGRAPHY APPARATUS

(71) Applicant: The Chinese University of Hong Kong, Hong Kong (CN)

(72) Inventors: Hon Ki Tsang, Ma On Shan (HK); Zunyue Zhang, Da Lian (CN); Kazi Tanvir Ahmmed, Chittagong (BD); Keyi Zhong, Shenzhen (CN); Dan Yi, Xiantao (CN)

(21) Appl. No.: 19/009,166

(22) Filed: Jan. 3, 2025

(51) Int. Cl. G01B 9/02091; G01B 9/02

(52) U.S. Cl. CPC G01B 9/02091; G01B 9/02044; G01B 9/02051

(57) ABSTRACT

A spectral domain optical coherence tomography (SD-OCT) apparatus includes an optical source system adapted to generate and transmit an optical signal; an optical coupler operatively coupled to a reference optical path and a scanning optical path; and at least two spectrometers including high speed detectors, wherein the spectrometers provide outputs that are utilized for differential detection of a wavelength channel. A spectral domain optical coherence tomography (SD-OCT) apparatus includes an optical source system adapted to generate and transmit an optical signal; an optical coupler operatively coupled to a reference light path and a scanning light path; at least two spectrometers comprising high speed detectors, wherein the spectrometers are interleaved.

### TECHNICAL FIELD

The present invention relates to an optical coherence tomography (OCT) apparatus, in particular the present invention relates to a spectral domain optical coherence tomography (OCT) apparatus.

### BACKGROUND

Since its inception in the early 1990's, OCT has been widely applied as an analytic tool. The OCT analysis systems developed over the past decades have been applied to many non-invasive imaging and measurement challenges.

Optical coherence tomography (OCT) is a method to measure three dimensional images using the coherence of light. Spectral domain OCT employs a low coherence broadband light source to measure the spectrally resolved interferogram of light reflected from an object, enabling the determination of distances to reflecting features. Current OCT systems typically utilize a single spectrometer to resolve optical interference between light reflected from the object and a constant length reference path. However, this configuration often results in the loss of half the reflected power, as only one port of the beamsplitter is used.

### SUMMARY OF THE INVENTION

The present invention relates to an improved spectral domain OCT apparatus that is able to operate with low coherence broadband light to spectrally resolve an interferogram of light reflected from an object.

According to a first aspect, there is provided a spectral domain optical coherence tomography (SD-OCT) apparatus comprising:
an optical source system adapted to generate and transmit an optical signal,
an optical coupler operatively coupled to a reference optical path and a scanning optical path,
at least two spectrometers comprising high speed detectors, wherein the spectrometers provide outputs that are utilized for differential detection of a wavelength channel.

In one example, the apparatus comprising a first sensing path and a second sensing path, wherein one spectrometer is positioned in the first sensing path and the other spectrometer is positioned in the second sensing path, wherein each spectrometer is adapted to receive optical signals and outputs of the spectrometers are utilized for differential detection of a wavelength channel.

In one example the optical signals may be visible light or infrared light or other light signal. The optical signals may be generated by an optical source e.g., a laser or a diode or other optical source.

In one example the apparatus comprising:
at least two edge couplers,
each edge coupler operatively coupled to a single spectrometer, the edge coupler configured to transmit optical signals to the spectrometer it is coupled to,
wherein the differential detection of a wavelength channel achieves a 3 dB improvement in signal to noise ratio.

In one example each spectrometer comprises a photodetector array.

In one example, the apparatus comprising:
at least two arrayed waveguide gratings (AWGs),
one AWG is operatively coupled to one photodetector array,
the AWGs are substantially identical to each other, and;
the AWGs configured to receive optical signals and transmit optical signals onto the photodetectors.

In one example the photodetectors are configured to measure the output power at each wavelength channel, and the outputs from the same wavelength channels provide two outputs for differential detection of a wavelength channel.

In one example the photodetectors may be an array of photodiodes.

In one example the photodetector arrays are integrated into two identical spectrometers that provide a differential readout for simultaneous measurement of all wavelength channels in the SD-OTC apparatus.

In one example the AWGs are identical to each other, and each photodetector measures the output from a corresponding AWG simultaneously and wherein the outputs from one AWG is processed by the corresponding output of the other AWG in a differential detection system.

In one example the apparatus comprising at least two micro ring resonators (MRRs), wherein the MRRs are operatively coupled to the AWGs and adapted to direct an optical signal from the optical coupler to an AWG.

In one example the apparatus comprising two edge couplers, one edge coupler positioned in the first sensing path and a second edge coupler positioned in the second sensing path.

In one example the apparatus comprising two edge couplers, wherein at least one edge coupler is coupled to a MRR and one AWG, and wherein the other edge coupler is coupled to the other MRR and other AWG.

The apparatus of any one of claims 5 to 11 wherein the MRRs are tunable and configured as frequency discriminators for achieving high spectral resolutions and the AWGs are wideband AWGs configured to identify the distinct wavelength for multiple possible wavelengths in the periodic resonances of an associated MRR.

According a second aspect, the present invention relates to a spectral domain optical coherence tomography (SD-OCT) apparatus comprising:
an optical source system adapted to generate and transmit an optical signal,
an optical coupler operatively coupled to a reference light path and a scanning light path,
at least two spectrometers comprising high speed detectors, wherein the spectrometers are interleaved.

In one example the apparatus comprising a plurality of arrayed waveguide gratings (AWGs) and an equal number of micro ring resonators (MRRs), wherein the AWGs are interleaved and the MRRs are interleaved.

In one example the plurality of AWGs comprise the same channel spacing, and the central wavelength of each AWG is offset by 1/M of the channel spacing from one AWG to the other AWG, wherein M is an integer that corresponds to the number of AWGs.

In one example the interleaved MRRs comprise a shift in the nominal frequency resonance positions, wherein the shift is equal to 1/M of the free spectral range (FSR) of at least one MRR.

In one example the apparatus comprising a single edge coupler, the edge coupler directly coupled to a single MRR.

In one example wherein the two AWGs form a single ended spectrometer.

In one example wherein the interleaved SD-OCT apparatus is configured to provide an improvement of 10 dB in the output signal of the spectrometer.

In one example the apparatus comprising two sets of interleaved MRRs and AWGs, wherein each set comprises two AWGs and two MRRs are interleaved, and; the two sets of interleaved MRRs and AWGs are arranged for differential detection of a wavelength channel.

In one example the apparatus comprising a first sensing path and a second sensing path, wherein the first sensing path comprises two interleaved AWGs, two interleaved MRRs and an edge coupler, and the second sensing path comprises two interleaved AWGs, two interleaved MRRs and an edge coupler, wherein the components of the first sensing path and second sensing path are arranged for differential detection.

In one example wherein the MRRs are tunable MRRs.

In one example the SD-OCT apparatus as described above is constructed on a silicon-on-insulator (SOI) platform.

According to a further aspect, the present invention relates to an integrated differential detection system comprising:
a plurality of arrayed waveguide gratings (AWGs) and an equal number of micro ring resonators (MRRs), wherein the AWGs are interleaved and the MRRs are interleaved.

In one example the plurality of AWGs comprise the same channel spacing, and the central wavelength of each AWG is offset by 1/M of the channel spacing from one AWG to the other AWG, wherein M is an integer that corresponds to the number of AWGs.

In one example the interleaved MRRs comprise a shift in the nominal frequency resonance positions, wherein the shift is equal to 1/M of the free spectral range (FSR) of at least one MRR.

According to a further aspect, the present invention relates to an integrated differential detection system comprising:
a first sensing path and a second sensing path,
wherein one spectrometer is positioned in the first sensing path and the other spectrometer is positioned in the second sensing path, wherein each spectrometer is adapted to receive optical signals and outputs of the spectrometers are utilized for differential detection of a wavelength channel.

In one example the optical signals may be visible light or infrared light or another light signal. The optical signals may be generated by an optical source e.g., a laser or a diode or other optical source.

In one example the apparatus comprising:
at least two edge couplers,
each edge coupler operatively coupled to a single spectrometer, the edge coupler configured to transmit optical signals to the spectrometer it is coupled to,
wherein the differential detection of a wavelength channel achieves a 3 dB improvement in signal to noise ratio.

In one example each spectrometer comprises a photodetector array.

In one example, the apparatus comprising:
at least two arrayed waveguide gratings (AWGs),
one AWG is operatively coupled to one photodetector array,
the AWGs are substantially identical to each other, and;
the AWGs configured to receive optical signals and transmit optical signals onto the photodetectors.

The term “comprising” (and its grammatical variations) as used herein are used in the inclusive sense of “having” or “including” and not in the sense of “consisting only of”.

It is to be understood that, if any prior art information is referred to herein, such reference does not constitute an admission that the information forms a part of the common general knowledge in the art.

### BRIEF DESCRIPTION OF THE DRAWINGS

Embodiments of the present invention will now be described, by way of example, with reference to the accompanying drawings in which:

FIG. 1 illustrates a schematic diagram of a differential spectral domain optical coherence tomography (SD-OCT) apparatus in accordance with the present invention.

FIG. 2 illustrates an example structure of an integrated differential detection system that may be used in the SD-OCT apparatus.

FIG. 3 illustrates an example of an integrated interleaved detection system that may be used in the SD-OCT apparatus.

FIG. 4 illustrates a normalized transmission spectrum of the test channels of the nominally identical AWGs integrated on the same chip.

FIG. 5A illustrates a transmission spectrum of the tandem MRR measured via a grating coupler.

FIG. 5B illustrates a transmission spectrum in 1310 nm to 1313 nm.

FIG. 6 illustrates a plot that indicates a simulation of the interleaved AWG.

FIG. 7A illustrates a normalised transmission spectrum of the interleaved AWGs.

FIG. 7B illustrates a normalised transmission spectrum of interleaved MRRs.

FIG. 8 illustrates a transmission spectrum obtained from one of the 16 channels of the single AWG using a single MRR.

FIG. 9 illustrates a transmission spectrum obtained from the two AWG channel passbands, with half from AWG2 and the other half from AWG1.

### DETAILED DESCRIPTION OF THE PREFERRED EMBODIMENTS

The foregoing describes only example forms of the present invention and modifications, obvious to those skilled in the art, can be made thereto without departing from the scope of the present invention.

In one example the present invention relates to a differential design of a spectral domain optical coherence tomograph (SD-OCT) apparatus. In this example SD-OCT apparatus comprising: an optical source system adapted to generate and transmit an optical signal, an optical coupler operatively coupled to a reference optical path and a scanning optical path, and at least two spectrometers comprising high speed detectors, wherein the spectrometers provide outputs that are utilized for differential detection of a wavelength channel.

The differential design utilizes a pair of optical spectrometers integrated on a silicon photonic chip. This configuration enables differential detection that directly interfaces with the complementary inputs of CMOS analogue circuits. The spectrometers may be integrated on a silicon photonic chip.

The differential design of an SD-OCT apparatus achieves a 3 dB improvement in the signal to noise ratio of the output of the SD-OCT apparatus. This significantly enhances measurement sensitivity and image quality output by the SD-OCT apparatus especially in low signal environments. Appropriate calibration of the spectral response from the dual spectrometers arranged for differential detection may cancel common-mode noise, leading to improved imaging.

In a further example the present invention relates to an interleaved design of a SD-OCT apparatus. In this example the SD-OCT apparatus comprising: an optical source system adapted to generate and transmit an optical signal, an optical coupler operatively coupled to a reference light path and a scanning light path, and at least two spectrometers comprising high speed detectors, wherein the spectrometers are interleaved.

In one example the apparatus comprising a plurality of arrayed waveguide gratings (AWGs) and an equal number of micro ring resonators (MRRs), wherein the AWGs are interleaved and the MRRs are interleaved.

In this interleaved design i.e., interleaved configuration provides a more uniform output from the high spectral resolution and wide band spectrometer based on the tandem arrangement of micro-ring resonator with arrayed waveguide gratings for use in a SD-OCT apparatus. The SD-OCT apparatus provides a 10 dB improvement in output uniformity.

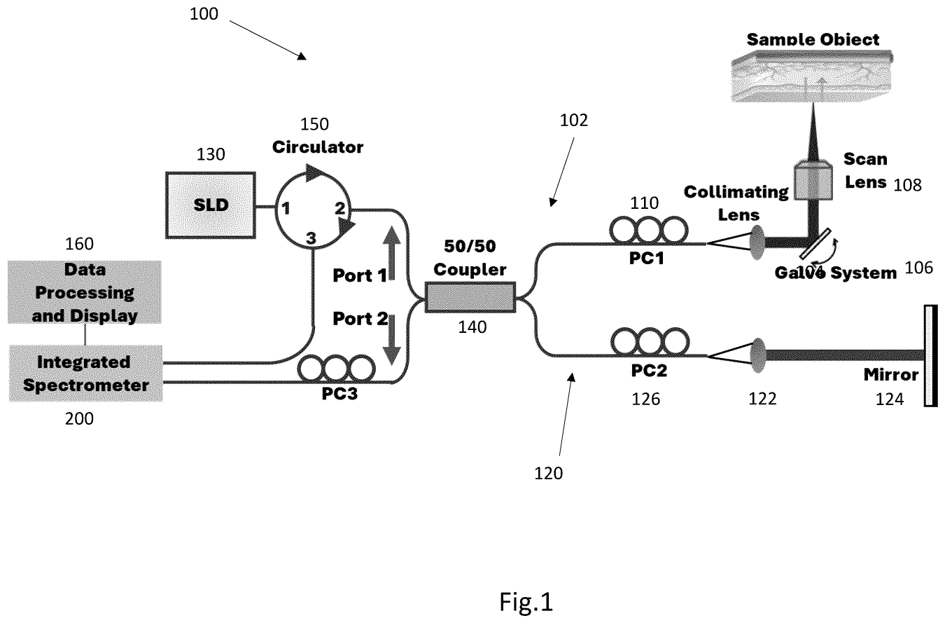

FIG. 1 illustrates a schematic diagram of a differential spectral domain optical coherence tomography apparatus 100. The SC-OCT apparatus 100 comprises a sensing path 102 and a reference path 120. The sensing path 102 defines a path that an optical signal is transmitted onto a sample object. The sensing path 102 may comprise a collimating lens 104 followed by galvo system e.g., a galvo mirror system 106 and a scan lens 108. The optical signal may be passed through a polarization controller 110 (PC1) and then passed through the components in the sensing path. The optical signal may be reflected off the sample. The reference path 120 may comprise a collimating lens 122 and a mirror 124 positioned at a known fixed distance. An optical signal may be provided along the reference path and reflect off the mirror 124. The reference path 120 may also comprise a polarization controller 126 (PC2). The polarization controllers 110 and 120 may be configured to control the polarity of the optical signal e.g., the light signal.

Both paths 102 and 120 may each include polarization controller labelled PC1 and PC2. The apparatus 100 may comprise an optical source 130 labelled SLD. The optical source is arranged to generate an optical signal. The optical signal may be visible light or a laser or infrared light. The optical source may be adapted to generate a low coherence, wide band optical signal. In one example the light source 130 may be a super luminescent diode that generates white light. The optical signal is passed through a 50:50 coupler 140 (i.e., a beam splitter). The beam splitter 140 is adapted to split the optical signal into the sensing path 102 and reference path 120. The 50:50 coupler functions as an optical coupler to couple the reference path and sensing path optical signals to the spectrometer for resolving and processing.

The reflected optical signals from the sensing path 102 and the reference path 120 are directed through the 50:50 coupler 140. The interference signals from the two output ports of the 50:50 coupler 140 (i.e., beam splitter) have complementary interference output intensities indicated as port 1 and port 2. These outputs are considered complementary because the maximum constructive interference output from one port corresponds to the minimum destructive output from the other port.

In a conventional OCT system, the information from one port is typically unused and only the signals from the other port are measured by the spectrometer. The OCT apparatus 100 comprises a circulator 150 that is operatively coupled to the outputs and directs outputs from both ports simultaneously to an integrated spectrometer 200 (i.e., integrated differential detection system). The spectrometer 200 may be coupled to a data processing and display system 160 that is configured to process the outputs from the spectrometer and generate an image of the sample e.g., images of a retina. Optionally the output line from the beam splitter 140 may include a third polarization controller labelled PC3.

The simultaneous signal acquisition of both output ports using the circulator 150 and the usage of differential measurement can improve measurement and is better suited for use with the differential inputs commonly available in the CMOS analogue front end (AFE) and analogue to digital converter (ADC) design.

The OCT apparatus 100 comprises at least two spectrometers comprising high speed detectors, wherein the spectrometers provide outputs that are utilized for differential detection of a wavelength channel. The integrated spectrometer 200 system (i.e., integrated differential detection system) may comprise two spectrometers 210, 220. The two spectrometers 210, 220 are arranged for differential detection. The two spectrometers 210, 220 may be implemented as a monolithic spectrometer.

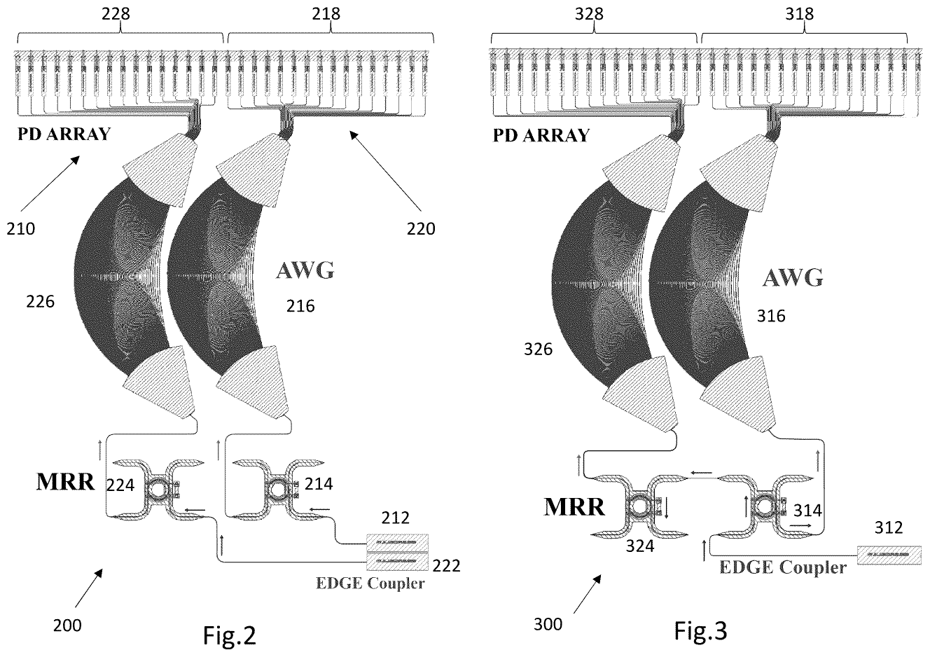

FIG. 2 illustrates an example structure of an integrated differential detection system i.e., an integrated spectrometer arrangement 200. The spectrometer arrangement 200 comprises a first edge coupler 212, a first micro ring resonator (MRR) 214 and a first arrayed waveguide grating (AWG) 216 arranged in a first sensing path. The spectrometer arrangement 200 further comprises a second edge coupler 222, a second MRR 224 and a second arrayed waveguide grating 226 arranged in a second sensing path.

The two AWGs 216, 226 may be substantially identical to each other. The MRRs 214, 224 may be tunable MRRs. The two edge couplers 212, 222 input complementary optical signals from the 50:50 coupler 140 (i.e., an interferometer). The AWGs 216, 226 may be coupled to or associated with a photodetector array. The first AWG 216 is operatively coupled to the first photodetector array 218 and the second AWG 226 is operatively coupled to the second photodetector array 228. The AWG 216 and photodetector array 218 define the first spectrometer 210. The AWG 226 and photodetector array 228 define the second spectrometer 220. The spectrometers are arranged to process optical data simultaneously in a differential manner.

In the conventional OCT system, the information from one port is typically unused and only the signals from the other port are measured by the spectrometer. The simultaneous signal acquisition of both of the two output ports using the circulator and the usage of differential measurement, as per the SD-OCT arrangement shown in FIG. 2 can improve measurement and is better suited for use with the differential inputs commonly available in the CMOS analogue front end (AFE) and analogue to digital converter (ADC) design. The two spectrometers 210, 220 i.e., the two AWGs with coupled photodetector arrays can make simultaneous differential measurements of all spectral channels. The spectrometers 210, 220 may be configured to measure the spectrally resolved complementary interference signals in the integrated arrays of on-chip photodetectors.

The integrated differential detection system 200 may be implemented as a monolithic photonic chip which combines the edge couplers, MRRs, AWGs and photodetector arrays onto a monolithic chip. In the example implementation the system 200 comprises a pair of tandem tuneable micro-ring resonators (MRR) (as frequency discriminators for achieving high spectral resolutions) and wideband arrayed waveguide grating (AWG) (which identify the distinct wavelength from the multiple possible wavelengths in the periodic resonances of the MRR) with integrated on-chip germanium photodiodes arrays as photodetectors as shown in the FIG. 2. The photodiode outputs from each spectrometer can be connected directly to the differential input stages of CMOS electronics.

The use of a photonic integration platform ensures that this approach can be cost effective and have smaller footprint than the use of conventional bulk-optics based spectrometers. The described arrangement of FIG. 2 enhances the signal-to-noise ratio by cancelling common-mode noise and increase the detected signal by 3 dB.

The integrated differential detection system 200 could enable highly portable OCT systems that offer superior performance without sacrificing mobility or convenience. The system 200 may be incorporated into an SD-OCT apparatus 100 as shown in FIG. 1, in the integrated spectrometer 200. This combination of enhanced signal integrity and portability addresses the growing demand for efficient, high-resolution imaging solutions, thereby facilitating better patient outcomes and expanding the reach of advanced diagnostic tools in diverse healthcare environments.

Conventional methods to improve signal integrity in OCT include increasing optical power, enhancing detector sensitivity, and employing advanced signal processing techniques. While these approaches can boost overall performance, they may not fully address noise issues. In contrast, differential detection as shown in FIG. 2 specifically targets noise reduction by using balanced detection techniques, which cancel common-mode noise, significantly enhancing the signal-to-noise ratio. This can enable clearer images.

In the example implementation of the SD-OCT apparatus was implemented on a single chop. The apparatus 100 comprises at two identical AWGs 216, 226 were integrated on a single chip. The illustrated design of FIG. 2 may be implemented on a 220 nm thick silicon-on-insulator platform with an operation range from 1290-1360 nm wavelength and occupies an area of approximately 2.8×2 mm². Each of the two identical spectrometers 210, 220 is implemented by tandem arrangement of a tuneable MRR 214, 224 and a multi-channel AWG 216, 226. Each AWG was designed to have 20 channels with 4 nm channel spacing and 70 nm optical bandwidth. To achieve high spectral resolution, each AWG spectral channel is connected to an integrated scanning MRR which may have the same free spectral range of 4 nm as the AWG channel spacing.

To achieve high spectral resolution, each MRR 214, 224 included both a metal heater and doped silicon heater to scan the wavelength in the whole free spectral range (FSR). The input to each MRR 214, 224 is coupled via broadband edge couplers, and each MRR had one input for differential operation. Sixteen of the 20 output channels of each AWG are connected to the array of integrated photodiodes. In the illustrated example four of the outputs are connected to optical grating couplers to facilitate optical testing of the device. The designed operational wavelength range of the photodiode connected readouts were 1290 nm to 1360 nm.

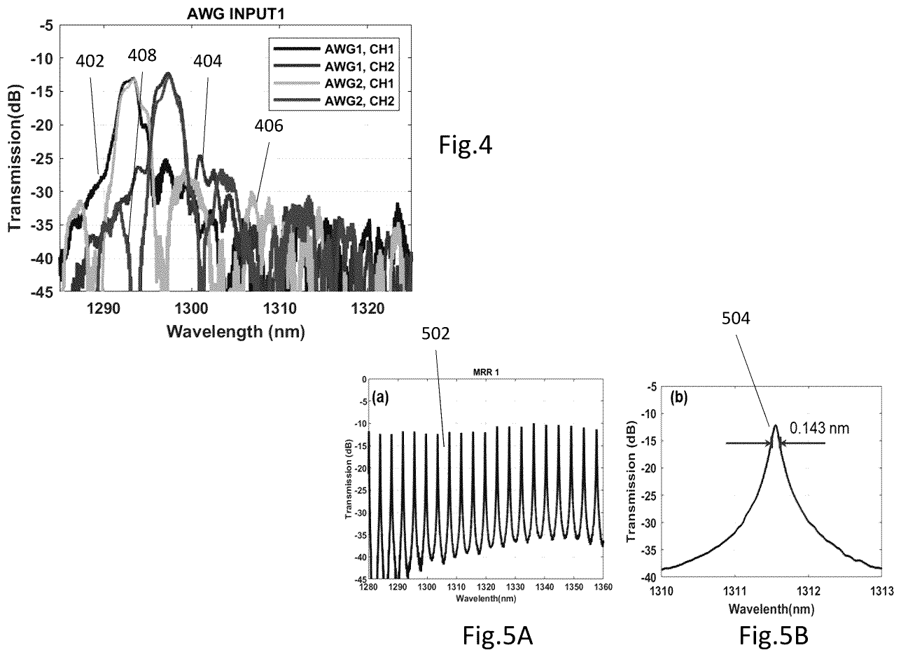

The integrated differential detection system 200 (i.e., integrated spectrometer) was tested. FIG. 4 illustrates a normalized transmission spectrum of the test channels of the nominally identical AWGs 216, 226 integrated on the same chip. FIG. 4 illustrates plot 402, 404 of the first AWG, and plots 406, 408 of the second AWG. The plots 402-408 of the two AWGs 216, 226 show that despite fabrication tolerances, they have a very similar spectral response and are suitable for use in differential detection. The measured channel spacing of 4 nm agrees with the designed target. The fabricated AWG has 2.6 dB insertion loss and approximately −14 dB inter-channel crosstalk at the off-centre wavelength channels.

The transmission spectrum of the tandem MRR measured via a grating coupler is shown in FIG. 5A. The spectrum 502 output is illustrated in FIG. 5A. Each MRR is designed to maintain a high extinction ratio in the wavelength range from 1280 nm to 1360 nm (27 dB extinction ratio at the centre wavelength). The MRR is measured to have 1.7 dB insertion loss and the 3 dB linewidth is measured to be 0.143 nm as shown in plot 504 of FIG. 5B. The FSR is measured to be 4 nm, which matches with the current MRR structure. With the fine spectral resolution of 0.143 nm, it is possible to have 28 spectrum channels for A-Scan with each 4 nm AWG Channel. A 70-nm optical bandwidth and a 0.15-nm channel spacing enabled by scanning the MRR across one free spectral range offer a total of 448 wavelength channels. The MRR equipped with a metal heater exhibits a rising and falling time of 16 μs, translating to a tuning speed of 61 kHz. Conversely, the PIN diode showcases a swift 15.5 ns rising and falling time, corresponding to an impressive 64 MHz tuning speed. This rapid tuning capability of the spectrometer enables it to excel in high-speed applications.

The use of high-speed MRR to yield 0.143 nm spectral resolution in scanning across the 4 nm passband of each AWG channel allows each photodiode connected at each of the outputs of the AWG to serve as a time-multiplexed equivalent of 28 (=4 nm/0.143 nm) different photodiodes output as shown in FIG. 5A.

In the example of FIGS. 2, 16 photodiodes were implemented for a single AWG (32 for two AWGs). The AWGs have a 32× faster ADC sampling rate than would otherwise be needed if the 448 photodiodes (896 for two AWGs) were used. The time division multiplexing approach does also offer the additional advantage of reducing the number of parallel ADC channels from 448 to 16, and this reduces the ADC array size, thus reducing the ADC chip fabrication cost and packaging costs. Moreover, the differential arrangement with two AWGs is more compatible with the digital input commonly implemented in CMOS analogue to digital conversion (ADC) microelectronics circuits and enables a better signal to noise ratio for the overall system.

In the known structure for a high resolution and broad optical bandwidth integrated spectrometer using the tandem scanning MRR with AWG and integrated with photodiode array, there exists the problem of having more than 10 dB variation in the output signal amplitude when the MRR is tuned across the passband of the AWG channel (in the gaussian shaped passband of each AWG channel there is low loss at the central portion of the AWG channel and more than 10 dB loss towards the edge of each AWG channel).

In one example the present invention relates to a spectral domain optical coherence tomography (SD-OCT) apparatus comprising: an optical source system adapted to generate and transmit an optical signal, an optical coupler operatively coupled to a reference light path and a scanning light path, at least two spectrometers comprising high speed detectors, wherein the spectrometers are interleaved.

In one example the SD-OTC apparatus comprises a plurality of arrayed waveguide gratings (AWGs) and an equal number of micro ring resonators (MRRs), wherein the AWGs are interleaved and the MRRs are interleaved. In one example the plurality of AWGs may comprise the same channel spacing, and the central wavelength of each AWG is offset by 1/M of the channel spacing from one AWG to the other AWG, wherein M is an integer that corresponds to the number of AWGs.

FIG. 3 illustrates an example architecture of an integrated interleaved detection system i.e. an interleaved detection system 300. The detection system 300 comprises tandem interleaved spectrometers 310, 320 with interleaved scanning MRRs.

As shown in FIG. 3, the system 300 comprises an edge coupler 312, a pair of interleaved MRRs 314, 324 and a pair of interleaved AWGs 316, 326. The edge coupler 312 is operatively coupled to the first MRR 314. The edge coupler 312 is adapted to direct an optical signal from the 50:50 coupler to the first MRR 314. The first MRR 314 and second MRR 324 are operatively coupled and interleaved. The first MRR 314 is operatively coupled to the first AWG 316. The second MRR 324 is operatively coupled to the second AWG 326.

Interleaving of a set of M different AWGs 316, 326 (where M is an integer larger than 1) is achieved by designing all M AWGs 316, 326 to have the same channel spacing. The central wavelength of each AWG 316, 326 is offset by 1/M of the channel spacing from one AWG to the next AWG in the set. The interleaved MRRs 314, 324 have a shift in their nominal (before active tuning) frequency resonance positions. In one example the shift is equal to 1/M of the FSR (free spectral range) of the MRR.

The AWGs 316, 326 each are coupled to a photodetector array 318, 328 respectively as shown FIG. 3. The first AWG 316 is coupled to the first photodetector array 318. The second AWG 326 is coupled to the second photodetector array 328. The photodetector arrays 318, 328 are configured to detect wavelength channels from a corresponding AWG. The photodetector arrays 318, 328 may be configured to measure or detect all spectral channels.

Corresponding AWG and photodetector array may define a spectrometer. For example, spectrometer 310 is defined by the first AWG 316 and the first photodetector array 318. Spectrometer 320 may be defined by the second AWG 326 and the second photodetector array 328.

The implementation of the interleaved MRR can be achieved by fine tuning the effective index of the ring waveguide by fine adjustment of the designed waveguide width. The tandem scanning of M interleaved MRRs with M interleaved AWGs yields a more uniform output since each MRR only needs to be tuned across the central 1/M part of the channel spacing.

The interleaved MRR architecture e.g., as shown in FIG. 3 reduces the required frequency scanning of each MRR by a factor of 1/M. This combination is distinct from the previous stationary (not-wavelength scanning) tandem MRRs and AWGs or the single scanning MRR in tandem with a single AWG as known in the prior art. In the illustrated example of the interleaved detection system the interleaved tandem tuneable MRRs serve as a narrow linewidth frequency discriminator to provide high spectral resolution within the passband of a single AWG channel. Additionally, the interleaved MRR with interleaved AWG enables better uniformity in output amplitude when used with the scanning MRR.

The illustrated detection system 300 as shown in FIG. 3 may be used as part of an SD-OCT apparatus. For example, the SD-OCT apparatus 100 as shown in FIG. 1 may include the detection system 300 that may be used as part of the apparatus 100.

An example implementation using two interleaved MRR with two interleaved AWG was designed and tested. Better uniformity was demonstrated as detailed further. By using M interleaved MRR with M interleaved AWGs (with each MRR resonance scanning the central portion of the passband of the corresponding AWG), the interleaved AWGs with tandem tuneable MRR achieve a better output uniformity and better amplitude resolution than the single tandem MRR and single AWG of the prior art.

Optionally a high-speed PIN phase shifter may be integrated in the MRR for fast wavelength scanning. When integrated with high-speed photodetector arrays, it is possible to achieve scanning speeds in the MHz range for high-speed A-scans in SD-OCT system 100.

The illustrated example of FIG. 3 may be an integrated interleaved SiPh chip. The detection system 300 includes a pair of interleaved AWGs 316, 326 which are designed to have channel spacing interleaving each other (i.e., the two AWGs have same channel spacing but the output of one AWG is shifted by half a channel spacing with respect to the other AWG), a pair of tuneable interleaved MRRs 314, 324 each with FSR equal to the channel spacing of the AWG. one edge coupler and array of single ended photodetectors. The two AWGs form a single ended spectrometer, and a duplication of this circuit would be needed for implementation of the differential detection with this scheme of tandem MRRs and interleaved AWGs.

Operation of the detection system 300 and testing will now be described. In use, input light passes through the M MRRs 314, 324, which are designed to have the same free spectrum range (FSR) but feature interleaved resonances such that each MRR in the set has a resonance offset of FSR/M relative to its neighbouring MRR. The arrangement shown in FIG. 3 effectively separates the light into different wavelength segments which can be measured by set of M broadband AWGs, whose channel spacing are designed to be equal to the FSR of the MRRs. The centre passband of each AWG channel is also interleaved. As a result, the light is split into different channels and detected by integrated high-speed photodetector array. This interleaved structure of the MRRs and AWGs not only enhances the signal but also enables a flatter optical response across the operational spectrum.

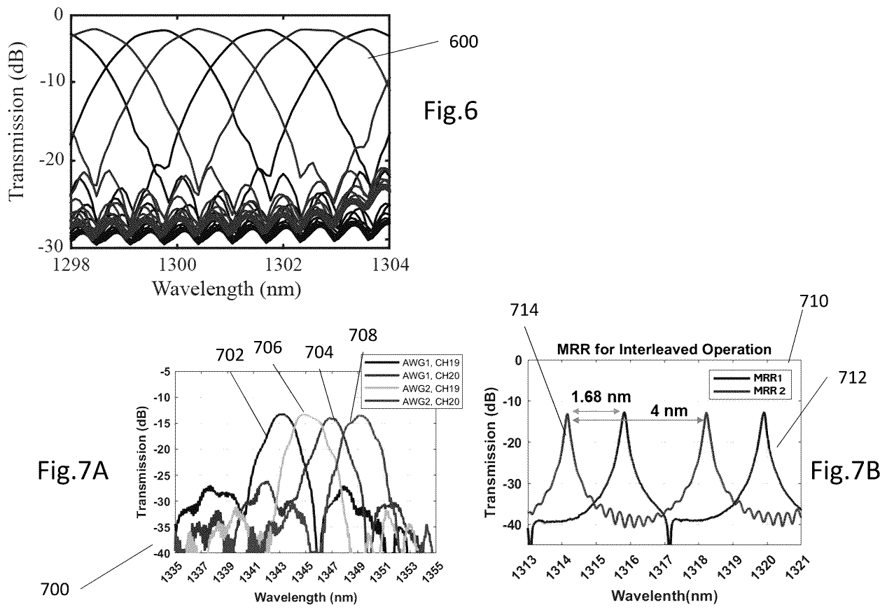

The tandem MRRs are designed with resonance wavelength offset by half of a FSR and the drop ports of the two MRRs are connected to the two AWG, respectively. The two AWGs are designed to have centre wavelength offset by half of a channel spacing, and only the channel centres are used when conducting wavelength scanning, as illustrated in FIG. 6. When doing the wavelength scanning, each ring will scan across the channel centre of the corresponding AWG, so that the whole transmission spectrum will be more flattened. Additionally, by utilizing the high-speed PIN phase shifter of the MRRs, detailed wavelength scanning can be achieved within each AWG channel. This enhances the total number of channels in the integrated optical spectrometer while reducing the number of photodetectors, thereby simplifying the system.

The tandem MRRs are designed with resonance wavelength offset by half of a FSR and the drop ports of the two MRRs are connected to the two AWG, respectively. The two AWGs may be designed to have centre wavelength offset by half of a channel spacing, and only the channel centres are used when conducting wavelength scanning, as illustrated in FIG. 6. FIG. 6 illustrates a plot 600 that indicates a simulation of the interleaved AWG. When doing the wavelength scanning, each ring will scan across the channel centre of the corresponding AWG, so that the whole transmission spectrum will be more flattened. Additionally, by utilizing the high-speed PIN phase shifter of the MRRs, detailed wavelength scanning can be achieved within each AWG channel. This enhances the total number of channels in the integrated optical spectrometer while reducing the number of photodetectors, thereby simplifying the system.

This integrated OCT system is constructed on a silicon-on-insulator (SOI) platform, utilizing commercially available SOI wafers and mature Complementary Metal-Oxide-Semiconductor (CMOS)-compatible technology, ensuring cost-effectiveness and suitability for bulk production.

The integrated interleaved optical spectrometer is characterized by a flatter optical response than the single tandem MRR+AWG, and have higher signal output amplitudes, high spectral resolution, wide optical bandwidth, and large channel number. Together with the high-speed photodetectors, this interleaved arrangement can significantly improve the overall performance of the OCT system, in terms of better imaging quality, more uniform performance, high-speed response, large imaging depth, and high axial resolution.

The interleaved arrangement 300 operation is explained. Initially, the input light passes through two MRRs 314, 324 that share the same free spectrum range (FSR) but feature interleaved resonances. This configuration effectively separates the light into two sections with narrow linewidths of the resonances in the MRRs. The separated light then travels through two broadband AWGs 316, 326, whose FSR aligns with that of the MRRs, and their transmission spectra are also interleaved. As a result, the light is split into different channels and detected by integrated high-speed photodetector array.

The system, in one example, may be implemented on a 220 nm thick silicon-on-insulator platform with an operation range from 1280-1350nm wavelength and fits within an overall area of about 2.8×2 mm². Each of the spectrometers is designed with a tuneable MRR and a multi-channel AWG. In this example each AWG may have 20 channels with 4 nm channel spacing and 70 nm optical bandwidth.

To achieve high spectral resolution, each AWG spectral channel is connected to an integrated scanning MRR which structured to have the same free spectral range of 4 nm as the AWG channel spacing. Each MRR 314, 324 may be designed with both a metal heater and doped silicon heater to scan the wavelength in the whole FSR. The cascaded MRRs are designed with resonance wavelength offset by 2 nm (half of FSR) and the drop ports of the two MRRs are connected to the two AWG, respectively. Light is launched to the spectrometer via the broadband edge couplers via the interleaved MRR as shown in FIG. 3. The two AWGs 316, 326 are designed to have centre wavelength offset by 2 nm (half of a channel spacing), and only the channel centres are used when conducting wavelength scanning. Sixteen of the 20 output channels of each AWG were connected via the MRR to the array of integrated photodiodes while four of the outputs were connected to optical grating couplers to facilitate optical testing of the device. The designed operational wavelength range of the photodiode connected readouts were 1280 nm to 1350 nm.

The normalized transmission spectrum of the test channels of the two interleaved AWGs is shown in FIG. 7A. The plot 700 in FIG. 7A indicates that each channel of the two AWGs has a channel spacing of 4 nm, with each common channel being offset by 2 nm with respect to each other. For instance, graph 702 of AWG1 (i.e., first AWG 316) and graph 706 of AWG2 (i.e., second AWG 326) have a 2 nm offset, aligning with the designed values. FIG. 7A illustrates two graphs 702, 704 of AWG1 and graphs 706, 708 of AWG2. The AWG exhibits a measured insertion loss of 2.6 dB and approximately −14 dB inter-channel crosstalk at the off-centre wavelength channels. The transmission spectrum of the MRR1 712 and MRR2 714 using the grating coupler is shown in plot 710 shown in FIG. 7B.

The MRR keeps high extinction ratio in the wavelength range from 1280 nm to 1360 nm (27 dB extinction ratio at the centre wavelength). The MRR is measured to have 1.7 dB insertion loss and the 3 dB linewidth is measured to be 0.143 pm. The FSR is measured to be 4 nm, which matches well with the design. The MRRs 314, 324 are designed to have a 2 nm offset with each other, but the measurement results show a 1.68 nm shift attributed to a fabrication error. To mitigate these deviations, tuning voltage offsets can be employed to effectively compensate for the variations, thereby ensuring precise spectral alignment and accuracy in the measurements. The MRR equipped with a metal heater exhibits a rising and falling time of 16 μs, translating to a tuning speed of 61 kHz. Conversely, the PIN diode showcases a swift 15.5 ns rising and falling time, corresponding to an impressive 64 MHz tuning speed. This rapid tuning capability of the spectrometer enables it to excel in high-speed applications.

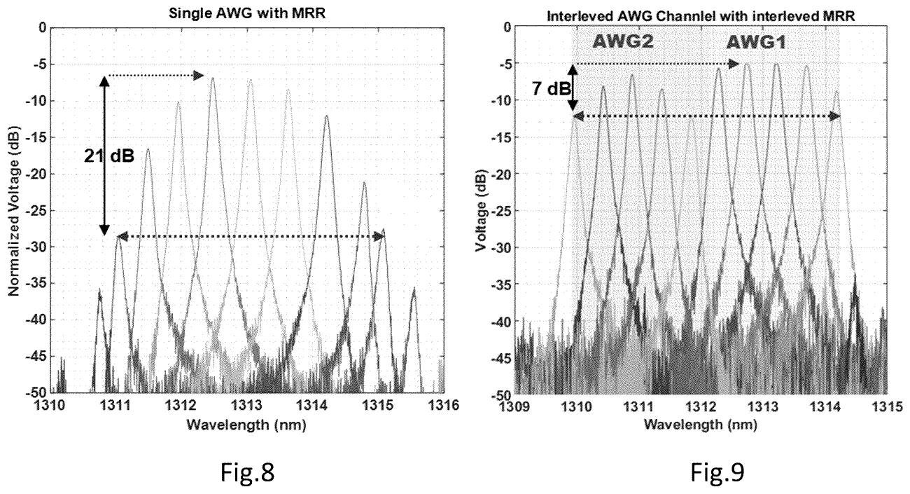

In a single AWG with tuneable MRRs, as the resonance wavelength of the MRR scans across the AWG channel, the output power fluctuates due to the Gaussian-shaped spectral envelope of the AWG channel, illustrated FIG. 8.

In one example, the edge channel close to 1311 nm drops in amplitude by 21 dB, compared with the maximum transmitted channel at a wavelength of 1312.5 nm. This variation leads to a lower signal-to-noise ratio for the wavelength channels located at the edges of the AWG passband.

In the present form of the system 300, there is an overlap of the wavelength channels from one AWG with the neighbouring channels from other AWGs. This allows the use of the central portion of each AWG channel passband with frequency discriminators. This setup results in a more uniform and higher output signal level. By utilizing the high-speed PIN phase shifter of the MRRs, detailed wavelength scanning can be achieved within each AWG channel. By utilizing two channel passbands, half from AWG1 and the other half from AWG2, this interleaved structure of the MRRs and AWGs not only enhances the signal but also enables a flatter optical response across the operational spectrum, as depicted in FIG. 9. In this example implementation with M=2, the edge channel near 1310 nm drops by only 7 dB, when compared with the maximum transmitted channel at a wavelength of 1312.5 nm.

This example system 300 yields an improvement of more than 10 dB compared to a single AWG with MRR. It is possible to use M>2 with more AWGs to overlap channels, enabling, for instance, to further reduce the amplitude variation. This approach yields a more consistent and higher output signal level compared to scenarios without channel overlap.

The SD-OCT apparatus 100 may comprise a combination of the differential arrangement and the interleaved arrangement. For example, the SD-OCT apparatus 100 may comprise two spectrometers, wherein spectrometers comprising high speed detectors, and wherein the spectrometers provide outputs that are utilized for differential detection of a wavelength channel. Each spectrometer may include the interleaved arrangement shown in FIG. 3. For example, each spectrometer may be defined by an edge coupler, two interleaved MRRs 314, 324, two AWGs 316, 324 and a photodetector array associated with each AWG. The OCT apparatus may include four total AWGs and four photodetector arrays. The SD-OCT arrangement disclosed herein may include both the differential arrangement and the interleaved arrangement.

The present invention improves the spectral resolution of integrated spectrometer while maintaining better output signal uniformity and low crosstalk in a highly portable platform. The global OCT market is projected to expand from $1.99 billion in 2024 to $3.32 billion by 2030, driven by increasing demand for high-resolution imaging across various medical applications, including ophthalmology, dermatology, and cardiology.

As healthcare increasingly moves toward point-of-care diagnostics, the need for portable OCT systems has become paramount. These devices allow healthcare professionals to perform non-invasive imaging directly at the patient's location, significantly improving accessibility to diagnostic services. By maintaining high level output signal with high spectral resolution over a wide optical wavelength range, the invention enables portable systems to deliver superior image quality, which is critical for accurate disease detection and monitoring.

Additionally, the rise of telemedicine and remote healthcare solutions further amplifies the demand for portable diagnostic tools. Healthcare providers require reliable imaging devices that can function effectively in diverse environments, from clinics to home healthcare settings. The OCT apparatus described herein is lightweight, high-performance OCT system that excels in signal integrity directly addresses these needs.

The SD-OCT apparatus as per the present invention provides several advantages. The apparatus provides improved Signal Integrity: The differential design enhances signal integrity by 3 dB compared to existing OCT systems, leading to clearer imaging and better depth resolution. The interleaved design improves signal uniformity by utilizing overlapping wavelength channels from multiple arrayed waveguide gratings (AWGs), allowing more efficient use of channel passbands with 10 dB larger output uniformity.

Additionally, the SD-OCT apparatus has improved portability. The SD-OCT is integrated on-chip differential detection methods and high-resolution optical spectrometers within a compact footprint, making the system highly portable for point-of-care applications. By minimizing the need for complex optical alignments and expensive components, the invention reduces manufacturing costs. The proposed OCT apparatus can be fabricated on commercial platforms such as silicon-on-insulator (SOI), silicon nitride, and InP, making it suitable for large-volume production.

The integration of high-speed PIN diodes for wavelength scanning enables the SD-OCT apparatus to operate at MHz-level A-scan rates, significantly advancing OCT technology for real-time imaging, compared to traditional line-scan cameras limited to a few hundred kHz.

The interleaved design e.g., as shown in FIG. 3 reduces power consumption by reducing the tuning range needed for frequency discriminators, as they only need to scan the central portion of each AWG channel passband. The invention is suitable for a wide range of medical applications, including ophthalmology and dermatology, facilitating real-time diagnostics in diverse healthcare settings. The use of micro-ring resonators (MRRs) with narrower resonance linewidths allows for higher spectral resolution, contributing to improved imaging depth for real-time 3D imaging while reducing the overall chip area and number of photodetectors required. The interleaved design minimizes power consumption by reducing the tuning range needed for the frequency discriminators since they only need to scan half of each channel passband (the central portion of the AWG passband) rather than the full channel passband.

The SD-OCT apparatus described herein is engineered to provide high resolution and uniform output, greatly enhancing overall imaging quality. Furthermore, the cost-effective silicon photonic OCT system is designed with CMOS compatibility in mind, enabling direct differential connection with CMOS AFE for the data readout circuits. This approach not only reduces costs but also ensures that our innovative solutions can be widely adopted in handheld OCT products and robust industrial metrology products.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

One or more of the components and functions illustrated the figures may be rearranged and/or combined into a single component or embodied in several components without departing from the scope of the invention. Additional elements or components may also be added without departing from the scope of the invention.

1. A spectral domain optical coherence tomography (SD-OCT) apparatus comprising:
an optical source system adapted to generate and transmit an optical signal,
an optical coupler operatively coupled to a reference optical path and a scanning optical path,
at least two spectrometers comprising high speed detectors, wherein the spectrometers provide outputs that are utilized for differential detection of a wavelength channel.

2. The apparatus of claim 1, further comprising a first sensing path and a second sensing path, wherein one spectrometer is positioned in the first sensing path and the other spectrometer is positioned in the second sensing path, wherein each spectrometer is adapted to receive optical signals and outputs of the spectrometers are utilized for differential detection of a wavelength channel.

3. The apparatus of claim 1, comprising:
at least two edge couplers,
each edge coupler operatively coupled to a single spectrometer, the edge coupler configured to transmit optical signals to the spectrometer it is coupled to,
wherein the differential detection of a wavelength channel achieves a 3 dB improvement in signal to noise ratio.

4. The apparatus of claim 1, wherein each spectrometer comprises a photodetector array.

5. The apparatus of claim 1, further comprising:
at least two arrayed waveguide gratings (AWGs),
one AWG is operatively coupled to one photodetector array,
the AWGs are substantially identical to each other, and;
the AWGs configured to receive optical signals and transmit optical signals onto the photodetectors.

6. The apparatus of claim 5, wherein the photodetectors are configured to measure the output power at each wavelength channel, and the outputs from the same wavelength channels provide two outputs for differential detection of a wavelength channel.

7. The apparatus of claim 6, wherein the photodetector arrays are integrated into two identical spectrometers that provide a differential readout for simultaneous measurement of all wavelength channels in the SD-OTC apparatus.

8. The apparatus of claim 6, wherein the AWGs are identical to each other, and each photodetector measures the output from a corresponding AWG simultaneously and wherein the outputs from one AWG is processed by the corresponding output of the other AWG in a differential detection system.

9. The apparatus of claim 8 further comprising at least two micro ring resonators (MRRs), wherein the MRRs are operatively coupled to the AWGs and adapted to direct an optical signal from the optical coupler to an AWG.

10. The apparatus of claim 2 further comprising two edge couplers, one edge coupler positioned in the first sensing path and a second edge coupler positioned in the second sensing path.

11. The apparatus of claim 6 further comprising two edge couplers, wherein at least one edge coupler is coupled to a MRR and one AWG, and wherein the other edge coupler is coupled to the other MRR and other AWG.

12. The apparatus of claim 5, wherein the MRRs are tunable and configured as frequency discriminators for achieving high spectral resolutions and the AWGs are wideband AWGs configured to identify the distinct wavelength for multiple possible wavelengths in the periodic resonances of an associated MRR.

13. A spectral domain optical coherence tomography (SD-OCT) apparatus comprising:
an optical source system adapted to generate and transmit an optical signal,
an optical coupler operatively coupled to a reference light path and a scanning light path,
at least two spectrometers comprising high speed detectors, wherein the spectrometers are interleaved.

14. The apparatus of claim 13 further comprising a plurality of arrayed waveguide gratings (AWGs) and an equal number of micro ring resonators (MRRs), wherein the AWGs are interleaved and the MRRs are interleaved.

15. The apparatus of claim 13, wherein the plurality of AWGs comprises the same channel spacing, and the central wavelength of each AWG is offset by 1/M of the channel spacing from one AWG to the other AWG, wherein M is an integer that corresponds to the number of AWGs.

16. The apparatus of claim 15, wherein the interleaved MRRs comprise a shift in the nominal frequency resonance positions, wherein the shift is equal to 1/M of the free spectral range (FSR) of at least one MRR.

17. The apparatus of claim 14 further comprising a single edge coupler, the edge coupler directly coupled to a single MRR.

18. The apparatus of claim 14, wherein the two AWGs form a single ended spectrometer.

19. The apparatus of claim 13, wherein the interleaved SD-OCT apparatus is configured to provide an improvement of 10dB in the output signal of the spectrometer.

20. The apparatus of claim 13 further comprising two sets of interleaved MRRs and AWGs, wherein each set comprises two AWGs and two MRRs are interleaved, and; the two sets of interleaved MRRs and AWGs are arranged for differential detection of a wavelength channel.

21. The apparatus of claim 20 further comprising a first sensing path and a second sensing path, wherein the first sensing path comprises two interleaved AWGs, two interleaved MRRs and an edge coupler, and the second sensing path comprises two interleaved AWGs, two interleaved MRRs and an edge coupler, wherein the components of the first sensing path and second sensing path are arranged for differential detection.

22. The apparatus of claim 13, wherein the MRRs are tunable MRRs.

23. A spectral domain optical coherence tomography (SD-OCT) apparatus comprising:
an optical source system adapted to generate and transmit an optical signal,
an optical coupler operatively coupled to a reference optical path and a scanning optical path,
at least two spectrometers comprising high speed detectors, wherein the spectrometers provide outputs that are utilized for differential detection of a wavelength channel,
wherein each spectrometer comprises an interleaved arrangement of two AWGs and two interleaved MRRs and a photodetector array coupled to each AWG according to claim 14.

24. The apparatus of claim 23, wherein the SD-OCT apparatus is constructed on a silicon-on-insulator (SOI) platform.
